(19) United States
(12) Patent Application Publication
(10) Pub. No.: US 2011/0297317 A1
(43) Pub. Date: Dec. 8, 2011

(54) ONE-PART STRUCTURAL EPOXY RESIN ADHESIVES CONTAINING DIMERIZED FATTY ACID/EPOXY RESIN ADDUCT AND A POLYOL

(76) Inventors: Andreas Lutz, Galgenen (CH); Daniel Schneider, Wadenswil (CH); Cathy Grossnickel, Wofhausen (CH); Christof Braendli, Niederhasli (CH)

(21) Appl. No.: 13/146,198

(22) PCT Filed: Feb. 3, 2010
(86) PCT No.: PCT/US10/22979

§ 371 Date: Jul. 26, 2011

Related U.S. Application Data
(60) Provisional application No. 61/155,542, filed on Feb. 26, 2009.

(51) Int. Cl. B32B 37/12; C09J 163/02

(52) U.S. Cl. 156/330; 523/455

(57) ABSTRACT

Structural adhesives containing a non-rubber-modified epoxy resin, an elastomeric toughener and a curing agent further include an epoxy-functional fatty acid oligomer and a polyol. The presence of the epoxy-functional fatty acid oligomer and a semi-crystalline or crystalline polyester polyol in combination increase the storage stability of the structural adhesive.

This application claims priority from U.S. Provisional Application No. 61/155,542, filed 26 Feb. 2009.

This invention relates to epoxy-based structural adhesives.

Epoxy resin based adhesives are used in many applications. In the automotive industry, epoxy resin adhesives are used in many bonding applications, including metal-metal bonding in frame and other structures in automobiles. Some of these adhesives must strongly resist failure during vehicle collision situations. Adhesives of this type are sometimes referred to as “crash durable adhesives”, or “CDAs”.

CDAs and other epoxy adhesives are usually formulated into either “one-part” or “two-part” formulations. In two-part formulations, the adhesive formulation is divided into two parts, one of which contains the epoxide compounds and the other of which contains the epoxide curing agents. The two parts have to be mixed together at the time of their use. The requirement for mixing means that some means must be provided to meter the parts accurately to obtain the proper mix ratios, and to ensure that the parts are mixed adequately so the formulation can cure consistently to form a cured adhesive having fully developed properties.

A one-part adhesive formulation allows one to avoid the metering and mixing steps at the point of application. In a one-part formulation, all components of the adhesive formulation, including the epoxides and the curing agents, are formed into a single blend. Curing is effected in most cases by exposing the formulation to elevated temperatures.

Because all of the reactive components are present in the one-part formulation, there is a tendency for the adhesive to cure prematurely. These adhesives are commonly manufactured and packaged weeks or months before they will be used, and they must remain in an uncured state throughout that period of time. Premature curing causes the product viscosity to increase, which can make it difficult to apply to a substrate. In extreme cases, the product becomes completely unusable.

The usual approach to solving this problem is through the selection of curing agents and catalysts. “Latent” curing agents and catalysts are available, and they are commonly used in one-part adhesive formulations. The latent materials are in some cases solid materials that have melting temperatures of 80° C. or more. They can be dispersed into the adhesive formulation in the form of solid particles that have little reactivity until they are heated and melted. In other cases, the latent materials may be encapsulated in a wax or polymeric shell. Heating melts or decomposes the encapsulant to release the active material. Another type of latent material has blocked functional groups. The blocked functional groups can be thermally deblocked to generate an active material.

Despite these attempts, there still remains a need to produce a more storage-stable one-part adhesive formulation. Greater storage stability often translates to a longer shelf-life for the product, but can also mean that the product is more stable to exposure to transient temperature excursions, as are sometimes seen during their transportation and storage.

Further improvements in storage-stability might be obtained by modifying the catalyst. However, changes in the catalyst can have a large effect on how the adhesive cures and on the properties of the cured adhesive. For example, changing catalysts or curing agents can accelerate or slow the cure. In some cases, the cured adhesive may lack desired characteristics such as mechanical strength and impact strength. Changes in the catalyst can also affect corrosion rates at the substrate-adhesive interface when the substrate is a metal. It would be desirable to provide a one-part epoxy adhesive that is more storage-stable, and which also possesses the desirable cure characteristics and properties that are obtained using conventional catalysts.

This invention is a one-part structural adhesive, comprising:

A) at least one non-rubber-modified epoxy resin;
B) a reactive toughener containing urethane and/or urea groups, and which has capped terminal isocyanate groups;
C) from 0.4 to 6% by weight of the structural adhesive of an epoxy-functionalized fatty acid oligomer;
D) from 2 to 10% by weight of the structural adhesive of a polyester polyol having a molecular weight of from 500 to 10,000 and which has a crystalline melting temperature of from 40 to 125° C., and
E) one or more epoxy curing agents.

The invention is also a method comprising applying the foregoing structural adhesive to the surfaces of two substrates, and curing the structural adhesive to form an adhesive bond between the two substrates. At least one and preferably both of the substrates are metals.

The presence of the epoxy-functionalized fatty acid oligomer and the polyol in combination has been found to make the one-part structural adhesive more storage stable. In particular, the adhesive has a reduced tendency to build viscosity over time when maintained under ordinary storage conditions. Under ordinary storage conditions, the adhesive is maintained in a sealed container so as to exclude contact with moisture and other chemicals, at a temperature from about 0 to about 50° C., i.e., below the expected curing temperature for the formulation. The reduced tendency of the product to build viscosity under these conditions translates straightforwardly into a longer shelf life, as more time is required until the product viscosity increases so much that the product is no longer useful.

A wide range of epoxy resins can be used as a non-rubber-modified epoxy resin, including those described at column 2 line 66 to column 4 line 24 of U.S. Pat. No. 4,734,332, incorporated herein by reference. The epoxy resin will contain an average of at least 2.0 epoxide groups per molecule.

Suitable epoxy resins include the diglycidyl ethers of polyhydric phenol compounds such as resorcinol, catechol, hydroquinone, bisphenol, bisphenol A, bisphenol AP (1,1-bis(4-hydroxylphenyl)-1-phenyl ethane), bisphenol F, bisphenol K and tetramethylbiphenol; diglycidyl ethers of aliphatic glycols and polyether glycols such as the diglycidyl ethers of C₂₋₂₄ alkylene glycols and poly(ethylene oxide) or poly(propylene oxide) glycols; polyglycidyl ethers of phenol-formaldehyde novolac resins, alkyl substituted phenol-formaldehyde resins (epoxy novolac resins), phenol-hydroxybenzaldehyde resins, cresol-hydroxybenzaldehyde resins, dicyclopentadiene-phenol resins and dicyclopentadiene-substituted phenol resins; and any combination of any two or more thereof.

Suitable epoxy resins include diglycidyl ethers of bisphenol A resins such as are sold by Dow Chemical under the designations D.E.R.® 330, D.E.R.® 331, D.E.R.® 332, D.E.R.® 383, D.E.R. 661 and D.E.R.® 662 resins.

Commercially available diglycidyl ethers of polyglycols that are useful include those sold as D.E.R.® 732 and D.E.R.® 736 by Dow Chemical.

Epoxy novolac resins can be used. Such resins are available commercially as D.E.N.® 354, D.E.N.® 431, D.E.N.® 438 and D.E.N.® 439 from Dow Chemical.

Other suitable additional epoxy resins are cycloaliphatic epoxides. A cycloaliphatic epoxide includes a saturated carbon ring having an epoxy oxygen bonded to two vicinal atoms in the carbon ring, as illustrated by the following structure IV:

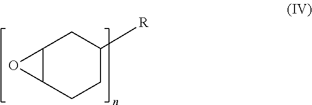

wherein R is an aliphatic, cycloaliphatic and/or aromatic group and n is a number from 1 to 10, preferably from 2 to 4. When n is 1, the cycloaliphatic epoxide is a monoepoxide. Di- or polyepoxides are formed when n is 2 or more. Mixtures of mono-, di- and/or polyepoxides can be used. Cycloaliphatic epoxy resins as described in U.S. Pat. No. 3,686,359, incorporated herein by reference, may be used in the present invention. Cycloaliphatic epoxy resins of particular interest are (3,4-epoxycyclohexyl-methyl)-3,4-epoxy-cyclohexane carboxylate, bis-(3,4-epoxycyclohexyl) adipate, vinylcyclohexene monoxide and mixtures thereof.

Other suitable epoxy resins include oxazolidone-containing compounds as described in U.S. Pat. No. 5,112,932. In addition, an advanced epoxy-isocyanate copolymer such as those sold commercially as D.E.R. 592 and D.E.R. 6508 (Dow Chemical) can be used.

The non-rubber-modified epoxy resin preferably is a bisphenol-type epoxy resin or mixture thereof with up to 20 percent by weight of another type of epoxy resin. The most preferred epoxy resins are bisphenol-A based epoxy resins and bisphenol-F based epoxy resins. These can have average epoxy equivalent weights of from about 170 to 600 or more, preferably from 225 to 400.

An especially preferred non-rubber-modified epoxy resin is a mixture of a diglycidyl ether of a polyhydric phenol, preferably bisphenol-A or bisphenol-F, having an epoxy equivalent weight of from 170 to 299, especially from 170 to 225, and a second diglycidyl ether of a polyhydric phenol, again preferably bisphenol-A or bisphenol-F, this one having an epoxy equivalent weight of at least 300, preferably from 310 to 600. The proportions of the two resins are preferably such that the mixture of the two resins has an average epoxy equivalent weight of from 225 to 400. The mixture optionally may also contain up to 20%, preferably up to 10%, of one or more other non-rubber-modified epoxy resins.

A non-rubber-modified epoxy resin preferably will constitute at least about 25 weight percent of the structural adhesive, more preferably at least about 30 weight percent, and still more preferably at least about 35 part weight percent. The non-rubber-modified epoxy resin may constitute up to about 60 weight percent of the structural adhesive, more preferably up to about 50 weight percent. These amounts include any non-rubber-modified epoxy resin that may be brought into the composition with other components that contain an epoxy resin as, as for example, a diluent or excess, unreacted reagent.

The elastomeric toughener is a liquid or low-melting elastomeric material which contains urethane and/or urea groups and has terminal capped isocyanate groups. The elastomeric toughener suitably contains, on average, from about 1.5, preferably from about 2.0, to about 8, preferably to about 6, more preferably to about 4, capped isocyanate groups per molecule.

The elastomeric toughener has capped isocyanate groups. The capping groups may be, for example, a phenolic compound, an aminophenolic compound, a primary or secondary aliphatic or cycloaliphatic amine, a benzyl alcohol, an aromatic or heteroaromatic amine, a benzyl amine or a thiol compound. The capping or blocking group may contain additional functional groups (such as phenolic OH groups) which do not react with epoxy groups under ordinary storage conditions, but the capping or blocking group may instead be devoid of such groups.

The toughener contains at least one internal segment that provides elastomeric character. It may contain two or more such segments. This segment may be a polyether segment or a segment of a butadiene homopolymer or copolymer. Segments of both types may be present in the toughener. Each polyether segment or segment of a butadiene homopolymer or copolymer preferably has a weight of from 800 to 5000 daltons, preferably from 1500 to 4000 daltons.

The elastomeric toughener may also contain residues of a branching agent, a chain extender, or both. Branching agents, for purposes of this invention, are polyol or polyamine compounds having a molecular weight of up to 750, preferably from 50 to 500, and at least three hydroxyl, primary amino and/or secondary amino groups per molecule. Branching agents provide branching to the toughener, and are useful to increase the functionality (i.e., number of capped isocyanate groups per molecule) of the toughener. Chain extenders, for purposes of this invention, are polyol or polyamine compounds having a molecular weight of up to 750, preferably from 50 to 500, and two hydroxyl, primary amino and/or secondary amino groups per molecule. Chain extenders help to increase the molecular weight of the elastomeric toughener without increasing functionality.

The elastomeric toughener suitably has a number average molecular weight from at least 3000, preferably at least 5000, to about 30,000, preferably to about 20,000 and more preferably to about 15,000. Molecular weights as used herein are determined according to GPC analysis, taking into account peaks in excess of 1000. The polydispersity (ratio of weight average molecular weight to number average molecular weight) is suitably from about 1 to about 4, preferably from about 1.5 to 2.5.

The elastomeric toughener should be soluble or dispersible in the remainder of the reactive components of the structural adhesive.

Suitable elastomeric tougheners and methods for preparing them are described, for example, in U.S. Pat. Nos. 5,202,390, 5,232,996, 5,278,257 and 6,660,805, U.S. Published Patent Application Nos. 2004/0229990, 2005/0070634, 2005/0209401 and 2006/0276601; WO 03/078163, WO 05/118734, EP 0 308 664, EP 1 431 325, EP 1 498 441, EP 1 648 950, EP 1 741 734 and EP 1 916 269.

The elastomeric toughener can be represented by the idealized structure (I)

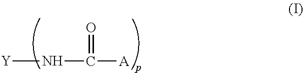

wherein p represents the average number of capped isocyanate groups per molecule. p is suitably at least 1.5, preferably at least 2, to 8, preferably to 6, more preferably to 4. Each A in structure I represents the residue, after removal of a hydrogen atom, of a capping group.

In structure I, Y is the residue of an isocyanate-terminated prepolymer after removal of the terminal isocyanate groups. Y contains at least one elastomeric segment. Each elastomeric segment preferably has a relatively high molecular weight, preferably a molecular weight of at least 800 daltons. The number average molecular weight of the elastomeric segment may be as high as 15000 daltons, and is preferably from 1500 to 10000 daltons, in each case. This elastomeric segment is preferably linear or at most slightly branched. The elastomeric segment(s) each may be a polyether segment or a segment of a butadiene homopolymer or copolymer, as described before. The Y group may contain one or more segments of each type. The Y group may contain urethane and/or urea groups, and may in addition contain residues (after removal of hydroxyl or amino groups, as the case may be) of one or more crosslinkers or chain extenders. Chain extenders may be aromatic or aliphatic diols, diamines or hydroxylamines.

The reactive toughener can be prepared by forming an isocyanate-terminated prepolymer, and then capping the terminal isocyanate groups with one or more capping agents. The isocyanate-terminated prepolymer can be prepared by reaction of one or more polyol or polyamine compounds with a stoichiometric excess of a polyisocyanate compound, preferably a diisocyanate compound. At least one of the polyol or polyamine compounds imparts elastomeric properties to the toughener.

The polyisocyanate may be an aromatic polyisocyanate, but it is preferably an aliphatic polyisocyanate such as isophorone diisocyanate, hexamethylene diisocyanate, hydrogenated toluene diisocyanate, hydrogenated methylene diphenylisocyanate (H₁₂MDI), and the like.

In the simplest case, only one polyol or polyamine is used to make the prepolymer. In such a case, the polyol or polyamine is made up of or contains at least one relatively high weight elastomeric segment as described before. However, it is also possible to use a mixture of polyols or polyamines to make the prepolymer. It is preferred that at least 50%, more preferably at least 80%, and even more preferably at least 90%, by weight of the polyol or polyamine materials used to make the prepolymer contain or are made up of at least one relatively high weight elastomeric segment as described before.

When a mixture of polyols/or polyamines is used to make the prepolymer, the polyisocyanate compound can be reacted all at once with the mixture to produce the prepolymer in a single step. Alternatively, the polyisocyanate may be reacted with each polyol or polyamine compound sequentially, or with various subsets thereof. The latter approach is often useful to produce a prepolymer having a more defined molecular structure.

The proportions of starting materials are suitably selected so that the prepolymer has an isocyanate content of from 0.5 to 6% by weight, more preferably from 1 to 5% by weight and even more preferably from 1.5 to 4% by weight. In terms of isocyanate equivalent weight, a preferred range is from 700 to 8400, a more preferred range is from 840 to 4200, and an even more preferred range is from 1050 to 2800.

The elastomeric toughener is then prepared from the prepolymer by reacting the isocyanate prepolymer with one or more capping agents. The proportions of starting materials are selected so that at least one mole of capping agent is provided per equivalent of isocyanate group on the prepolymer. Such a ratio of starting materials allows for the capping reaction to proceed until the isocyanate groups are essentially all consumed, without significantly advancing the prepolymer.

Suitable capping agents include secondary amine compounds such as dialkyl amines like diisopropyl amine, diethylamine, di-t-butylamine, di-n-butylamine and the like.

Other suitable capping agents include compounds that contain at least one phenolic hydroxyl group, i.e., a hydroxyl group bonded directly to a carbon atom of an aromatic ring. The phenolic compound may have two or more phenolic hydroxyl groups, but preferably contains only one phenolic hydroxyl group. The phenolic compound may contain other substituent groups, but these preferably are not reactive with an isocyanate group under the conditions of the capping reaction. Alkenyl groups, especially allyl groups, are of particular interest. Other suitable substituent groups include alkyl groups, which may be linear, branched or cycloalkyl; aromatic groups such as phenyl, alkyl-substituted phenyl, alkenyl-substituted phenyl and the like; aryl-substituted alkyl groups; and phenol-substituted alkyl groups, wherein the phenol substituent group may itself be unsubstituted or substituted. Examples of suitable phenolic compounds include phenol, cresol, allylphenol (especially o-allylphenol), resorcinol, catechol, hydroquinone, bisphenol, bisphenol A, bisphenol AP (1,1-bis(4-hydroxylphenyl)-1-phenyl ethane), bisphenol F, bisphenol K, bisphenol M, tetramethylbiphenol and o,o′-diallyl-bisphenol A.

Other useful capping agents include hydroxy-functional acrylate or methacrylate compounds that have one or more, especially one, hydroxyl group. Hydroxyl-functional acrylate and methacrylate compounds are preferred. Among the suitable capping agents of this type are 2-hydroxyethylacrylate, 2-hydroxypropylacrylate, 4-hydroxybutylacrylate, 2-hydroxybutylacrylate, 2-aminopropylacrylate, 2-hydroxyethylmethacrylate, 2-hydroxypropylmethacrylate, 4-hydroxybutylmethacrylate, 2-hydroxybutylmethacrylate, and the like.

Hydroxyl-functional epoxides are another useful type of capping agent. Suitable hydroxy-functional epoxides are compounds that have at least one epoxy group and one or more, especially one, hydroxyl group per molecule. The hydroxyl group should be significantly more reactive with an isocyanate group than the epoxide group(s). The hydroxyl groups are preferably bonded directly to an aliphatic carbon atom. The hydroxyl-functional epoxide is preferably devoid of aromatic groups. A preferred hydroxyl-functional epoxide is glycidol.

The toughener should constitute at least 5 weight percent of the adhesive composition. Better results are typically seen when the amount of toughener is at least 8 weight percent or at least 10 weight percent. The toughener may constitute up to 45 weight percent thereof, preferably up to 30 weight percent and more preferably up to 25 weight percent. The amount of toughener that is needed to provide good properties, particularly good low temperature properties, in any particular adhesive composition may depend somewhat on the other components of the composition, and may depend somewhat on the molecular weight of the toughener.

The epoxy-functionalized fatty acid oligomer is an oligomeric unsaturated fatty acid, in which the carboxylic acid groups have been capped or otherwise converted to introduce terminal epoxide groups. The oligomeric fatty acid may have a degree of polymerization of from about 2 to about 4. The starting fatty acid may have, for example, from 14 to 24 carbon atoms, with fatty acids having from 16 to 18 carbon atoms being preferred. The oligomer preferably is hydrogenated to remove any residual carbon-carbon double bonds that may be present after the oligomerization reaction. Useful oligomeric fatty acids include the so-called “dimer fatty acid” products that are readily commercially available. Those dimer fatty acid products have an average degree of polymerization of from 1.9 to 2.5, from about 1.9 to 2.5 carboxylic acid groups/molecule and from 32 to 45 carbon atoms. The epoxy-functionalized fatty acid oligomer can be prepared by capping the carboxylic acid groups with a polyepoxide, including any of the epoxy resin materials described hereinbefore. Polyphenols such as bisphenol A or bisphenol F are especially preferred for this purpose. It is preferred to conduct the capping reaction with at least one mole of the polyepoxide per equivalent of carboxylic acid groups in the oligomeric fatty acid, in order to cap the carboxylic acid groups without significant chain extension. A greater excess of the polyepoxide is more preferred, as this leads to a product that includes the epoxy-functionalized fatty acid oligomer and some quantity of excess, unreacted polyepoxide.

The epoxy-functionalized fatty acid oligomer should constitute from about 0.4 to 6% of the total weight of the adhesive. A preferred amount is from 1 to 3%. For purposes of this invention, the weight of the epoxy-functionalized fatty acid oligomer does not include any excess, unreacted polyepoxide that may be present. Any such excess polyepoxide counts as part of the non-rubber-modified portion of the structural adhesive. In the case in which the epoxy-functionalized fatty acid oligomer is formed by capping a fatty acid oligomer with a polyepoxide, the weight of the epoxy-functionalized fatty acid oligomer can be calculated as the weight of the starting fatty acid oligomer plus the weight of one mole of the polyepoxide per equivalent of the fatty acid oligomer used in the capping reaction.

The structural adhesive also contains a crystalline or semi-crystalline polyester polyol having a molecular weight of from 500 to 10000, preferably from 1000 to 4000. The polyol has a crystalline melting temperature of from 40 to 125° C. It may contain from about 1.8 to 4, preferably from 1.8 to 2.5 hydroxyl groups per molecule, on average. Suitable polyester polyols include those available commercially from Evonik Industries under the trade name Dynacoll™. Specific polyester polyol products include Dynacoll™ 7300, Dynacoll™ 7380 and Dynacoll™ 7381.

The polyol suitably constitutes from 2 to 10 percent of the weight of the adhesive composition. A preferred amount is from 3 to 7 percent by weight.

The structural adhesive also contains a curing agent. The curing agent is selected together with any catalysts such that the adhesive cures rapidly when heated to a temperature of 80° C. or greater, preferably 140° C. or greater, but cures very slowly if at all at room temperature (˜22° C.) and temperatures up to at least 50° C. Suitable curing agents include materials such as boron trichloride/amine and boron trifluoride/amine complexes, dicyandiamide, melamine, diallylmelamine, guanamines such as acetoguanamine and benzoguanamine, aminotriazoles such as 3-amino-1,2,4-triazole, hydrazides such as adipic dihydrazide, stearic dihydrazide, isophthalic dihydrazide, semicarbazide, cyanoacetamide, and aromatic polyamines such as diaminodiphenylsulphones. The use of dicyandiamide, isophthalic acid dihydrazide, adipic acid dihydrazide and/or 4,4′-diaminodiphenylsulphone is particularly preferred.

The curing agent is used in an amount sufficient to cure the composition. Typically, enough of the curing agent is provided to consume at least 80% of the epoxide groups present in the composition. A large excess of that amount needed to consume the epoxide groups is generally not needed. Preferably, the curing agent constitutes at least about 1.5 weight percent of the structural adhesive, more preferably at least about 2.5 weight percent and even more preferably at least 3.0 weight percent. The curing agent preferably constitutes up to about 15 weight percent of the structural adhesive composition, more preferably up to about 10 weight percent, and most preferably up to about 8 weight percent.

The structural adhesive will in most cases contain a catalyst to promote the cure of the adhesive, i.e., the reaction of epoxy groups with epoxide-reactive groups on the curing agent and other components of the adhesive. The catalyst may be encapsulated or otherwise be a latent type which becomes active only upon exposure to elevated temperatures. Among preferred epoxy catalysts are ureas such as p-chlorophenyl-N,N-dimethylurea (Monuron), 3-phenyl-1,1-dimethylurea (Phenuron), 3,4-dichlorophenyl-N,N-dimethylurea (Diuron), N-(3-chloro-4-methylphenyl)-N′,N′-dimethylurea (Chlortoluron), tert-acryl- or alkylene amines like benzyldimethylamine, 2,4,6-tris(dimethylaminomethyl)phenol, piperidine or derivates thereof, imidazole derivates, in general C₁-C₁₂ alkylene imidazole or N-arylimidazols, such as 2-ethyl-2-methylimidazol, or N-butylimidazol, 6-caprolactam, a preferred catalyst is 2,4,6-tris(dimethylaminomethyl)phenol integrated into a poly(p-vinylphenol) matrix (as described in European patent EP 0 197 892).

Preferably, the catalyst is present in an amount of at least about 0.1 weight percent of the structural adhesive, and more preferably at least about 0.5 weight percent. Preferably, the catalyst constitutes up to about 2 weight percent of the structural adhesive, more preferably up to about 1.0 weight percent, and most preferably up to about 0.7 weight percent.

The structural adhesive of the invention may contain various other optional components.

One such optional component is a liquid rubber-modified epoxy resin. A rubber-modified epoxy resin for purposes of this invention is a reaction product of an epoxy resin and at least one liquid rubber that has epoxide-reactive groups, such as amino or preferably carboxyl groups. The resulting adduct has reactive epoxide groups which can be cured further when the structural adhesive is cured. It is preferred that at least a portion of the liquid rubber has a glass transition temperature (T_{g}) of −40° C. or lower, especially −50° C. or lower. Preferably, each of the rubbers (when more than one is used) has a glass transition temperature of −25° C. or lower. The rubber T_{g} may be as low as −100° C. or even lower.

The liquid rubber is preferably a homopolymer or copolymer of a conjugated diene, especially a diene/nitrile copolymer. The conjugated diene rubber is preferably butadiene or isoprene, with butadiene being especially preferred. The preferred nitrile monomer is acrylonitrile. Preferred copolymers are butadiene-acrylonitrile copolymers. Carboxyl-terminated rubbers are preferred. The molecular weight (Mₙ) of the rubber is suitably from about 2000 to about 6000, more preferably from about 3000 to about 5000.

Suitable carboxyl-functional butadiene and butadiene/acrylonitrile rubbers are commercially available from Noveon under the tradenames Hycar® 2000X162 carboxyl-terminated butadiene homopolymer, Hycar® 1300X31, Hycar® 1300X8, Hycar® 1300X13, Hycar® 1300X9 and Hycar® 1300X18 carboxyl-terminated butadiene/acrylonitrile copolymers. A suitable amine-terminated butadiene/acrylonitrile copolymer is sold under the tradename Hycar® 1300X21.

The rubber is formed into an epoxy-terminated adduct by reaction with an excess of a polyepoxide. A ratio of at least one mole of polyepoxide per equivalent of epoxy-reactive groups on the rubber is preferred. Typically, the rubber and an excess of the polyepoxide are mixed together with a polymerization catalyst and heated to a temperature of about 100 to about 250° C. in order to form the adduct. Suitable catalysts include those described before. Preferred catalysts for forming the rubber-modified epoxy resin include phenyl dimethyl urea and triphenyl phosphine.

A wide variety of epoxy resins can be used to make the rubber-modified epoxy resin, including any of those described above. Preferred polyepoxides are liquid or solid glycidyl ethers of a bisphenol such as bisphenol A or bisphenol F.

The rubber-modified epoxy resin(s), if present at all, may constitute about 1 weight percent of the structural adhesive or more, preferably at least about 2 weight percent. The rubber-modified epoxy resin may constitute up to about 25 weight percent of the structural adhesive, more preferably up to about 20 weight percent, and even more preferably up to about 15 weight percent.

The structural adhesive of the invention may contain one or more core-shell rubbers. The core-shell rubber is a particulate material having a rubbery core. The rubbery core preferably has a T_{g} of less than −20° C., more preferably less than −50° C. and even more preferably less than −70° C. The T_{g} of the rubbery core may be below −100° C. The core-shell rubber also has at least one shell portion that preferably has a T_{g} of at least 50° C. By “core”, it is meant an internal portion of the core-shell rubber. The core may form the center of the core-shell particle, or an internal shell or domain of the core-shell rubber. A shell is a portion of the core-shell rubber that is exterior to the rubbery core. The shell portion (or portions) typically forms the outermost portion of the core-shell rubber particle. The shell material is preferably grafted onto the core or is crosslinked or both. The rubbery core may constitute from 50 to 95%, especially from 60 to 90%, of the weight of the core-shell rubber particle.

The core of the core-shell rubber may be a polymer or copolymer of a conjugated diene such as butadiene, or a lower alkyl acrylate such as n-butyl-, ethyl-, isobutyl- or 2-ethylhexylacrylate. The core polymer may in addition contain up to 20% by weight of other copolymerized monounsaturated monomers such as styrene, vinyl acetate, vinyl chloride, methyl methacrylate, and the like. The core polymer is optionally crosslinked. The core polymer optionally contains up to 5% of a copolymerized graft-linking monomer having two or more sites of unsaturation of unequal reactivity, such as diallyl maleate, monoallyl fumarate, allyl methacrylate, and the like, at least one of the reactive sites being non-conjugated.

The core polymer may also be a silicone rubber. These materials often have glass transition temperatures below −100° C. Core-shell rubbers having a silicone rubber core include those commercially available from Wacker Chemie, Munich, Germany, under the trade name Genioperl™.

The shell polymer, which is optionally chemically grafted or crosslinked to the rubber core, is preferably polymerized from at least one lower alkyl methacrylate such as methyl-, ethyl- or t-butyl methacrylate.

A particularly preferred type of core-shell rubber is of the type described in EP 1 632 533 A1. The core-shell rubber is preferably dispersed in a polymer or an epoxy resin, also as described in EP 1 632 533 A1. Preferred core-shell rubbers include those sold by Kaneka Corporation under the designation Kaneka Kane Ace, including Kaneka Kane Ace MX 156 and Kaneka Kane Ace MX 120 core-shell rubber dispersions. The products contain the core-shell rubber particles pre-dispersed in an epoxy resin, at a concentration of approximately 25%. The epoxy resin contained in those products will form all or part of the non-rubber-modified epoxy resin component of the structural adhesive of the invention.

The core-shell rubber particles can constitute from 0 to 15 weight percent of the structural adhesive.

The total rubber content of the structural adhesive of the invention can range from as little as 0 weight percent to as high as 30 weight percent. A preferred rubber content for a crash durable adhesive is from 1 weight percent to as much as 20 weight percent, preferably from 2 to 15 weight percent and more preferably from 4 to 15 weight percent.

Total rubber content is calculated for purposes of this invention by determining the weight of core-shell rubber, plus the weight contributed by the liquid rubber portion of any rubber-modified epoxy resin as may be used. No portion of the elastomeric toughener is considered in calculating total rubber content. In each case, the weight of unreacted (non-rubber-modified) epoxy resins and/or other carriers, diluents, dispersants or other ingredients that may be contained in the core-shell rubber product or rubber-modified epoxy resin is not included. The weight of the shell portion of the core-shell rubber is counted as part of the total rubber content for purposes of this invention.

At least one filler, rheology modifier and/or pigment is preferably present in the structural adhesive. These can perform several functions, such as (1) modifying the rheology of the adhesive in a desirable way, (2) reducing overall cost per unit weight, (3) absorbing moisture or oils from the adhesive or from a substrate to which it is applied, and/or (4) promoting cohesive, rather than adhesive, failure. Examples of these materials include calcium carbonate, calcium oxide, talc, carbon black, textile fibers, glass particles or fibers, aramid pulp, boron fibers, carbon fibers, mineral silicates, mica, powdered quartz, hydrated aluminum oxide, bentonite, wollastonite, kaolin, fumed silica, silica aerogel or metal powders such as aluminum powder or iron powder. Another filler of particular interest is a microballoon having an average particle size of up to 200 microns and density of up to 0.2 g/cc. The particle size is preferably about 25 to 150 microns and the density is preferably from about 0.05 to about 0.15 g/cc. The microballoons can be of the expanded or the heat expandable types. Heat expandable microballoons which are suitable for reducing density include those commercially available from Dualite Corporation under the trade designation Dualite™, and those sold by Akzo Nobel under the trade designation Expancel™.

Fillers, pigment and rheology modifiers are preferably are used in an aggregate amount of about 2 parts per hundred parts of adhesive composition or greater, more preferably about 5 parts per hundred parts of adhesive composition or greater. They preferably are present in an amount of up to about 25 weight percent of the structural adhesive, more preferably up to about 20 weight percent, and most preferably up to about 15 weight percent.

The structural adhesive can further contain other additives such as diluents, plasticizers, extenders, pigments and dyes, fire-retarding agents, thixotropic agents, expanding agents, flow control agents, adhesion promoters and antioxidants. Suitable expanding agents include both physical and chemical type agents. The adhesive may also contain a thermoplastic powder such as polyvinylbutyral as a gelling agent for a pregelling process.

The presence of both the polyester polyol and the epoxy-functionalized fatty acid oligomer has been found to make the structural adhesive more storage stable, as indicated by a reduced tendency to increase in viscosity over time under ordinary storage conditions. Storage stability can be evaluated by storing the structural adhesive under a nitrogen atmosphere at 23° C. or 30° C. for 24 weeks, and measuring the viscosity of the adhesive before and after storage. Evaluations at 23° C. model typical indoor storage conditions, as in a typical climate-controlled warehouse setting. Evaluations at 30° C. model conditions that might be encountered during warehousing and transportation during warmer months of the year, and thus represents more stringent aging conditions. Under the 23° C. test, the structural adhesive of the invention often exhibits in increase in viscosity from 0% to 150%, more typically from 50 to 100%, over the 24-week period. At 30° test, the structural adhesive of the invention often exhibits in increase in viscosity from 0% to 300%, more typically from 100 to 250%, over the 24-week period. These increases in viscosity are calculated as 100% times (B−A)/A, where B is the viscosity at the end of the test and A is the viscosity at the beginning of the test. For purpose of these evaluations, viscosities are measured at 45° C. and a shear rate of 10 reciprocal seconds. A suitable measuring device is a Bohlin rheometer CS-50 cone-plate 4° angle 20 mm cone-diameter, or equivalent device. The viscosity measurements using this device are taken by ramping the shear rate up from 0.1 to 10 reciprocal seconds and back. Viscosity is taken at a shear rate of 10 reciprocal seconds during the ramp up.

The adhesive composition can be applied by any convenient technique. It can be applied cold or be applied warm if desired. It can be applied by extruding it from a robot into bead form on the substrate, it can be applied using mechanical application methods such as a caulking gun, or any other manual application means, and it can also be applied using jet spraying methods such as a steaming method or a swirl technique. The swirl technique is applied using an apparatus well known to one skilled in the art such as pumps, control systems, dosing gun assemblies, remote dosing devices and application guns. Preferably, the adhesive is applied to the substrate using a jet spraying or streaming process. Generally, the adhesive is applied to one or both substrates. The substrates are contacted such that the adhesive is located between the substrates to be bonded together.

After application, the structural adhesive is cured by heating to a temperature at which the curing agent initiates cure of the epoxy resin composition. Generally, this temperature is about 80° C. or above, preferably about 140° C. or above. The preferred temperature does not exceed 200° C.

The adhesive of the invention can be used to bond a variety of substrates together including wood, metal, coated metal, aluminum, a variety of plastic and filled plastic substrates, fiberglass and the like. In one preferred embodiment, the adhesive is used to bond parts of automobiles together. Such parts can be steel, coated steel, galvanized steel, aluminum, coated aluminum, plastic and filled plastic substrates.

An application of particular interest is bonding of automotive frame components to each other or to other components. The frame components are often metals such as cold rolled steel, galvanized metals, or aluminum. The components that are to be bonded to the frame components can also be metals as just described, or can be other metals, plastics, composite materials, and the like.

Adhesion to brittle metals such as galvaneal is of particular interest in the automotive industry. Galvaneal tends to have a zinc-iron surface that is somewhat rich in iron content and is brittle for that reason. A particular advantage of this invention is that the cured adhesive bonds well to brittle metals such as galvaneal. Another application of particular interest is the bonding of aerospace components, particularly exterior metal components or other metal components that are exposed to ambient atmospheric conditions during flight.

Assembled automotive frame members are usually coated with a coating material that requires a bake cure. The coating is typically baked at temperatures that may range from 140° C. to over 200° C. In such cases, it is often convenient to apply the structural adhesive to the frame components, then apply the coating, and cure the adhesive at the same time the coating is baked and cured.

The adhesive composition once cured preferably has a Young's modulus of about 1000 MPa as measured according to DIN EN ISO 527-1. Preferably the Young's modulus is about 1200 MPa or greater, more preferably at least 1500 MPa. Preferably, the cured adhesive demonstrates a tensile strength of about 20 MPa or greater, more preferably about 25 MPa or greater, and most preferably about 35 MPa or greater. Preferably, the lap shear strength of a 1.5 mm thick cured adhesive layer on cold rolled steel (CRS) and galvaneal is about 15 MPa or greater, more preferably about 20 MPa or greater, and most preferably about 25 MPa or greater measured according to DIN EN 1465.

The cured adhesive of the invention demonstrates excellent adhesive properties (such as lap shear strength and impact peel strength) over a range of temperatures down to −40° C. or lower.

The following examples are provided to illustrate the invention but are not intended to limit the scope thereof. All parts and percentages are by weight unless otherwise indicated.

Products used in the following examples are identified as follows:

Epoxy Resin Mixture is a blend of a solid diglycidyl ether of bisphenol A (D.E.R.™ 671, from Dow Chemical) and two liquid diglycidyl ethers of bisphenol A (D.E.R.™ 330 and D.E.R.™ 331, both from Dow Chemical) at an approximate weight ratio of 37:17:46.

Struktol™ 3614 is a reaction product of approximately 60% of a liquid diglycidyl ether of bisphenol F and 40% of Hycar 1300X13 rubber (a carboxy-terminated butadiene-acrylonitrile copolymer having a T_{g} less than −40° C., available from Noveon). It is commercially available from Schill & Seilacher.

Struktol™ 3604 is a reaction product of approximately 60% a liquid diglycidyl ether of bisphenol A and 40% of Hycar 1300X8 rubber (a carboxy-terminated butadiene-acrylonitrile copolymer having a T_{g} of about −52° C., available from Noveon). It is commercially available from Schill & Seilacher.

The Toughener is an elastomeric toughener is an isocyanate-terminated polyurethane prepolymer prepared from a polyether polyol and an aliphatic diisocyanate, in which the isocyanate groups are capped with o,o-diallyl bisphenol A, and is made as described in Example 13 of EP 308 664.

Polyester premix is a blend of 80 weight percent D.E.R.™ 330 epoxy resin and 20 weight percent of Dynacoll™ 7330 polyester polyol. Dynacoll™ 7330 polyester polyol is nominally difunctional and has a molecular weight of about 3500. D.E.R.™ 330 is a liquid diglycidyl ether of bisphenol A, available from The Dow Chemical Company. It has an epoxy equivalent weight of approximately 180.

Epoxide-functional fatty acid oligomer is a reaction product of 12.5% of a 36 carbon atom, fully hydrogenated dimerized fatty acid (available from Sigma Aldrich) and 87.3% of D.E.R.330 epoxy resin. The reaction product contains about 25% by weight of an epoxide-capped fatty acid oligomer and about 75% by weight of excess, unreacted epoxy resin.

Dynasilan A-187 is an epoxy silane available from General Electric Silicones.

Amicure™ CG-1200G is a cyanoguanidine epoxy hardener available from Air Products and Chemicals.

EP796 is tris (2,4,6-dimethylaminomethyl)phenol in a poly(vinylphenol) matrix.

### Structural Adhesive Examples 1-2 and Comparative Adhesives A and B

One-part, heat activated adhesives are prepared from the following formulations described in Table 1.

TABLE 1

| | Parts by Weight | | | |
|---|---|---|---|---|
| Component | Ex. 1 | Ex. 2 | Comp. A | Comp. B |
| Toughener | 17.8 | 17.8 | 17.8 | 17.8 |
| Struktol 3614 | 7.4 | 7.4 | 7.4 | 7.4 |
| Struktol 3604 | 7.4 | 7.4 | 7.4 | 7.4 |
| Epoxy Resin Mixture | 5.9 | 8.4 | 15.9 | 33.0 |
| Polyester Premix | 24.8 | 24.8 | 24.8 | 0 |
| Epoxide-functional | 10 | 7.5 | 0 | 7.5 |
| fatty acid oligomer | | | | |
| Versatic acid | 0.6 | 0.6 | 0.6 | 0.6 |
| monoepoxy ester | | | | |
| Dynasilan A-187 | 0.4 | 0.4 | 0.4 | 0.4 |
| Colorants | 1.0 | 1.0 | 1.0 | 0.1 |
| Fumed Silica | 7.9 | 7.9 | 7.9 | 5.4 |
| EP 796 | 0.8 | 0.8 | 0.8 | 0.8 |
| Amicure CG 1200G | 3.2 | 3.2 | 3.2 | 3.2 |
| Fillers | 12.8 | 12.8 | 12.8 | 12.9 |
| Polybutyral resin | 0 | 0 | 0 | 3.5 |
| % Epoxide-functional | 2.5 | 1.9 | 0 | 1.9 |
| fatty acid oligomer | | | | |
| % Polyester polyol | 5.0 | 5.0 | 5.0 | 0 |

Storage stability is evaluated by measuring the increase in the viscosity of each uncured adhesive over a period of 24 weeks, when stored under nitrogen at 23° C. and at 30° C. Viscosities are measured at 45° C. by using a Bohlin rheometer CS-50 cone-plate 4° angle 20 mm cone-diameter. The shear rate is ramped up from 0.1 to 10 reciprocal seconds and back. Viscosity is taken at a shear rate of 10 reciprocal seconds during the ramp up. Results are as indicated in Table 2.

TABLE 2

| | Ex. Or Comparative Sample No. | | | |
|---|---|---|---|---|
| | Ex. 1 | Ex. 2 | Comp. A | Comp. B |
| 23° C. Storage Stability | | | | |
| Initial Viscosity, Pa · s (A) | 224 | 289 | 329 | 220 |
| Visc. after 24 weeks, Pa · s (B) | 416 | 560 | 1150 | 580 |
| Change in viscosity (B − A) | 192 | 271 | 821 | 360 |
| % Increase (100% × [(B − A)/A]) | 86% | 94% | 250% | 165% |
| 30° C. Storage Stability | | | | |
| Initial Viscosity, Pa · s (A) | 224 | 289 | 329 | 220 |
| Visc. after 24 weeks, Pa · s (B) | 592 | 901 | 1780 | 1210 |
| Change in viscosity (B − A) | 368 | 612 | 1451 | 990 |
| % Increase (100% × [(B − A)/A]) | 164% | 212% | 441% | 450% |

The data in Table 2 shows that the combination of the epoxide-functional oligomeric fatty acid and the polyol improves storage stability by reducing the rate of viscosity increase at both 23° C. and 30° C. storage temperatures. When only one of these components is present in the structural adhesive, the viscosity increases significantly faster at both the 23° C. and 30° C. temperatures. In addition, the magnitude of the final viscosity is higher in the cases of Comparative Samples A and B.

Impact peel testing is performed in accordance with ISO 11343 wedge impact method. Testing is performed at an operating speed of 2 m/sec. Impact peel testing is performed at 23° C., and strength in N/mm is measured.

Test coupons for the impact peel testing are 90 mm×20 mm with a bonded area of 30×20 mm. The samples are prepared by wiping them with acetone. A 0.15 mm×10 mm wide Teflon tape is applied to the coupons to define the bond area. The structural adhesive is then applied to the bond area of latter coupon and squeezed onto the first coupon to prepare each test specimen. The adhesive layer is 0.2 mm thick. Duplicate samples are cured for 30 minutes at 180° C.

Duplicate test coupons are prepared and are evaluated for lap shear strength in accordance with DIN EN 1465. Testing is performed at a test speed of 10 mm/minute. Testing is performed at 23° C. Test samples are prepared using each adhesive. The bonded area in each case is 25×10 mm. The adhesive layer is 0.2 mm thick. Duplicate test specimens are cured at for 30 minutes at 180° C.

Results of the physical property testing are as indicated in Table 3.

TABLE 3

| | Impact | |
|---|---|---|
| Ex. or Comp. | Peel Str. | Lap Shear |
| Sample No. | (N/mm) | Str. (MPa) |
| 1 | 44 | 26 |
| 2 | 49 | 27 |
| Comp. A* | 44 | 27 |
| Comp. B* | 41 | 30 |

These data show that the presence of both the epoxide-functional fatty acid oligomer and the polyol has at most a small effect on mechanical properties.

What is claimed is:

1. A one-part structural adhesive, comprising:
A) at least one non-rubber-modified epoxy resin;
B) a reactive toughener containing urethane and/or urea groups, and which has capped terminal isocyanate groups;
C) from 0.4 to 6% by weight of the structural adhesive of an epoxy-functionalized fatty acid oligomer;
D) from 2 to 10% by weight of the structural adhesive of a crystalline or semi-crystalline polyester polyol having a hydroxyl equivalent weight of from 500 to 10,000 and which has a crystalline melting temperature of from 40 to 125° C., and
E) one or more epoxy curing agents.

2. The structural adhesive of claim 1, which contains from 1 to 3% by weight of component C, and component C is a dimer fatty acid having from 32 to 45 carbon atoms and from 1.9 to 2.5 carboxyl groups per molecule in which the carboxylic acid groups have been capped with a polyepoxide.

3. The structural adhesive of claim 1 or 2, which contains from 3 to 7% of component D, and component D has a molecular weight of from 1000 to 4000 and from 1.8 to 2.5 hydroxyl groups per molecule.

4. The structural adhesive of any preceding claim, wherein component A is a diglycidyl ether of a polyhydric phenol.

5. The structural adhesive of any preceding claim, which contains from 10 to 25% by weight of component B, and component B has a number average molecular weight of from 5000 to 15,000.

6. The structural adhesive of any preceding claim, wherein component B includes at least one internal polyether segment or butadiene homopolymer or copolymer segment having a molecular weight of from 1500 to 4000.

7. The structural adhesive of any preceding claim, which increases in viscosity by no more than 300% of its initial viscosity at 45° C. when stored under nitrogen at 30° C. for 24 weeks.

8. The structural adhesive of any preceding claim, which increases in viscosity by from 100 to 250% of its initial viscosity at 45° C. when stored under nitrogen at 30° C. for 24 weeks.

9. The structural adhesive of any preceding claim, which further comprises liquid rubber-modified epoxy resin, a core-shell rubber, or both a liquid rubber-modified epoxy resin and a core-shell rubber.

10. A method comprising applying the structural adhesive of any of claims 1-9 to the surfaces of two substrates, and curing the structural adhesive to form an adhesive bond between the two substrates.
